(19) United States
(12) Patent Application Publication
(10) Pub. No.: US 2012/0166667 A1
(43) Pub. Date: Jun. 28, 2012

(54) Streaming media

(76) Inventor: Edward Hall, Newbury (GB)

(21) Appl. No.: 12/930,045

(22) Filed: Dec. 22, 2010

(51) Int. Cl. G06F 15/16

(52) U.S. Cl. 709/231

(57) ABSTRACT

Method and system for streaming media data comprising: transmitting a first media description file and at least a portion of media data to a media renderer, wherein the first media description file contains initial data referencing segments of the media data used to start rendering the media data on the media renderer and a link to a second media description file associated with the media data. Transmitting the second media description file to the media renderer in response to a request initiated by following the link contained in the first media file after the media renderer starts to render the media data, wherein the second media description file contains further data referencing segments of the media data used to continue rendering the media data on the media renderer. The media description files may be media presentation description transmitted over HTTP.

### TECHNICAL FIELD

This application relates to a system and method for transmitting and receiving streaming media and in particular streamed video and audio content over a mobile data connection.

### BACKGROUND OF THE INVENTION

HTTP streaming media, especially on the Internet, makes use of a memory buffer on a client device or browser to maintain a continuous stream of media output provided to a viewer. The buffer may continue to fill as the media is displayed. This may be known as progressive download. Should the viewer decide to terminate the session then any unplayed media in the buffer represents a waste of bandwidth that was utilised to send the unnecessary data across a network to the client.

As an enhancement to this system, metadata describing the media data may be sent along with the media data. These metadata may include segment descriptions to assist the client or viewer in jumping to different sections of the media data. The metadata may also include location information specifying where any optional extras in the media data may be located, such as subtitles and alternative audio to enable multi-language video. The metadata may also describe any alternative resolution video to enable maintenance of the media stream under variable bandwidth conditions. Such metadata may be transmitted in the form a manifest file called a media presentation description (MPD) downloaded from a streaming server to a client before the media file is played or viewed.

“Format for HTTP Streaming Media Presentation Description” Tdoc S4-100020 from 3GPP (25-29 Jan. 2010), which is incorporated herein by reference, describes the MPD schema in further detail.

However, whilst this MPD is useful to the client once downloaded, its initial download can become a bottleneck as it prevents the media from playing until it is received in its entirety.

For example, an MPD describing a feature-film length video with multiple alternative representations can be 1 MB or more in size. Therefore, this can introduce a significant delay, especially if the client is attached to a low-bandwidth bearer, especially in a mobile environment.

Therefore, there is required a method and system that overcomes these problems whilst retaining the advantages of MPD.

### SUMMARY OF THE INVENTION

Against this background and in accordance with a first aspect of the system described herein there is provided a method of streaming media data comprising the steps of: transmitting a first media description file and at least a portion of media data to a media renderer, wherein the first media description file contains initial data referencing segments of the media data used to start rendering the media data on the media renderer and a link to a second media description file associated with the media data; and transmitting the second media description file to the media renderer in response to a request initiated by following the link contained in the first media file after the media renderer starts to render the media data, wherein the second media description file contains further data referencing segments of the media data used to continue rendering the media data on the media renderer. Therefore, a media stream may commence rendering on a rendering device (e.g. client, browser, mobile device, cell phone, etc.) quickly and before a media description file for the entire media date would have been received otherwise. The media data may be video, audio, audio-visual, text and game data, for example.

The second media description file may be larger than then first media description file.

Optionally, the media renderer may be selected from the group consisting of: video player, audio player, browser, computer, mobile device, cell phone, PDA, tablet computer, laptop computer and e-book reader. Other rendering devices may be used.

The link may be a hyperlink. This simplifies the request especially in a HTTP environment.

Optionally, the first and second media description files may either or both be XML files. Other formats may be used.

The first and second media description files may be media presentation description, MDP files.

Optionally, the first media description file may be less than about 100 kB or less than 1 MB. The smaller the initial file the less of a bottleneck it presents to initiating rendering of the media data.

The first media description file, the second media description file and the media data may be transmitted over HTTP. Other protocols may be used.

Optionally, the media data may be a live stream of data. This can be a live video feed for example.

According to a second aspect of the system described herein, there is provided a method of receiving streamed media data comprising the steps of: receiving on a media renderer a first media description file and at least a portion of media data, wherein the first media description file contains initial data referencing segments of the media data and a link to a second media description file associated with the media data; initiating a rendering of the media data using the initial data contained in the first media description file; issuing a request for the linked second media description file; and receiving the second media description file in response to the request, wherein the second media description file contains further data referencing segments of the media data used to continue rendering the media data on the media renderer.

The request for the second media description file may be issued after the rendering of the media data starts. Therefore, the request and receiving the second typically larger, media description file is silent to a viewer or listener of the rendered media.

The second media description file may be received during rendering of the media data.

Optionally, the media data and the media description files may be communicated over a mobile network.

The methods may be implemented as instructions within a computer program and stored as a computer-readable medium or transmitted as a signal. The computer program may be executed on one or more computers or networks of computers.

According to a third aspect of the system described herein there is provided a streaming media server comprising: a supply of media data; and a processor arranged or configured to receive from a requestor a request for media data and in response transmit to the requestor media data from the supply and a first media description file, wherein the first media description file contains initial data referencing segments of the media data used to start rendering the media data on the requestor and a link to a second media description file associated with the media data, and transmit in response to a response from the requestor following the link the second media description file, wherein the second media description file contains further data referencing segments of the media data used to continue rendering the digital work on the media renderer. The supply of media data may be a database or computer storage media containing pre-recorded files or the supply may be a live media feed. The media description files may be associated with the media data and stored together or separate.

It should be noted that any feature described above may be used with any particular aspect or embodiment of the system described herein.

### BRIEF DESCRIPTION OF THE FIGURES

Embodiments of the system described herein will now be described by way of example only and with reference to the accompanying drawings, in which:

FIG. 1 shows a flow chart of a method for streaming media data, given by way of example only, according to an embodiment of the system described herein; and

FIG. 2 a schematic diagram of a system for streaming media data according to the method of FIG. 1.

It should be noted that the figures are illustrated for simplicity and are not necessarily drawn to scale.

### DETAILED DESCRIPTION OF VARIOUS EMBODIMENTS

A streaming media session may be initiated on a media renderer or client, such as a browser on a cell phone, by a user selecting a link and therefore requesting a portion of selected media. In the following examples, the streaming media contains audio and video but the streamed media may take other forms.

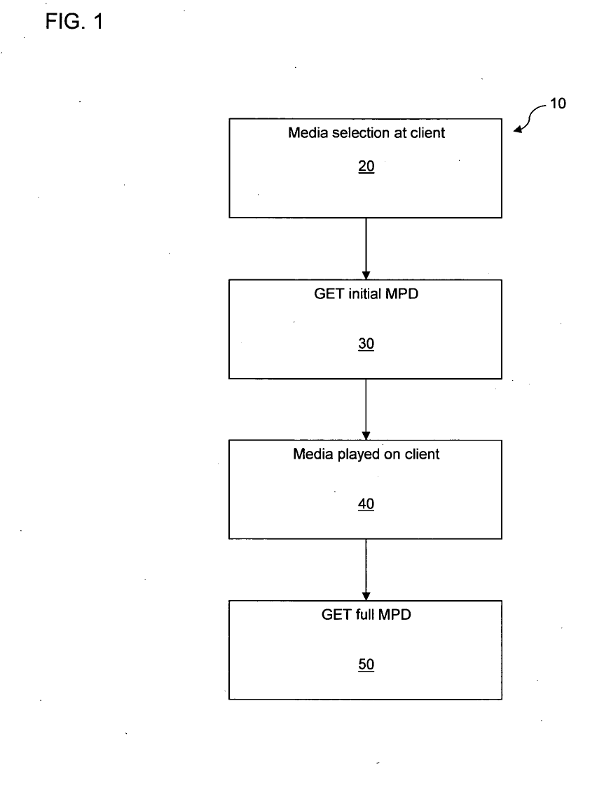

FIG. 1 shows a flow diagram illustrating a method 10 that is used to obtain streamed video on a client device according to an embodiment of the system described herein. The video is selected at the client device at step 20 and this may take the form of the user clicking or otherwise selecting a hyperlink to a video file or continuous content. At step 30, the client GETs an initial media description file in the form of a media presentation description (MPD). This initial MPD should be small in size (less than about 100 kB). This initial MPD contains enough information to start the streaming session and reference the first few seconds of the video (up to approximately 60 seconds of content).

Even in a low bandwidth environment, the initial MPD may be downloaded quickly in less than several seconds. As soon as the initial MPD is downloaded onto the client, then the media starts to play on the client at step 40. The media data or video file may be streamed and/or buffered as appropriate at this time.

As well as including initial data referencing segments at the start of the video data, the initial MPD contains a hyperlink to a second full media description file also in the form of an MPD associated with the media data or video file and contains further data referencing segments of the media data used beyond the initial few seconds of streamed content referenced by the initial MPD.

After the media starts to be displayed on the client or browser, the hyperlink is followed by the client and the full MPD is downloaded simultaneously with the media data using a GET command (step 50).

Therefore, by the time the video content referenced in the initial MPD has been played, the full MPD should have been acquired and fully downloaded so that the streaming process may continue uninterrupted. Furthermore, the client may make use of all facilities contained within the full MPD as this references all of the segments and any alternative content in the media data.

Furthermore, if the user decides to end the streaming session soon after initiation, then downloading the full MPD may be avoided (or at least avoiding the download of any unreceived portion of the full MPD), thereby saving bandwidth resources of the server or media supplier and data bearer. This may be especially important in a mobile environment.

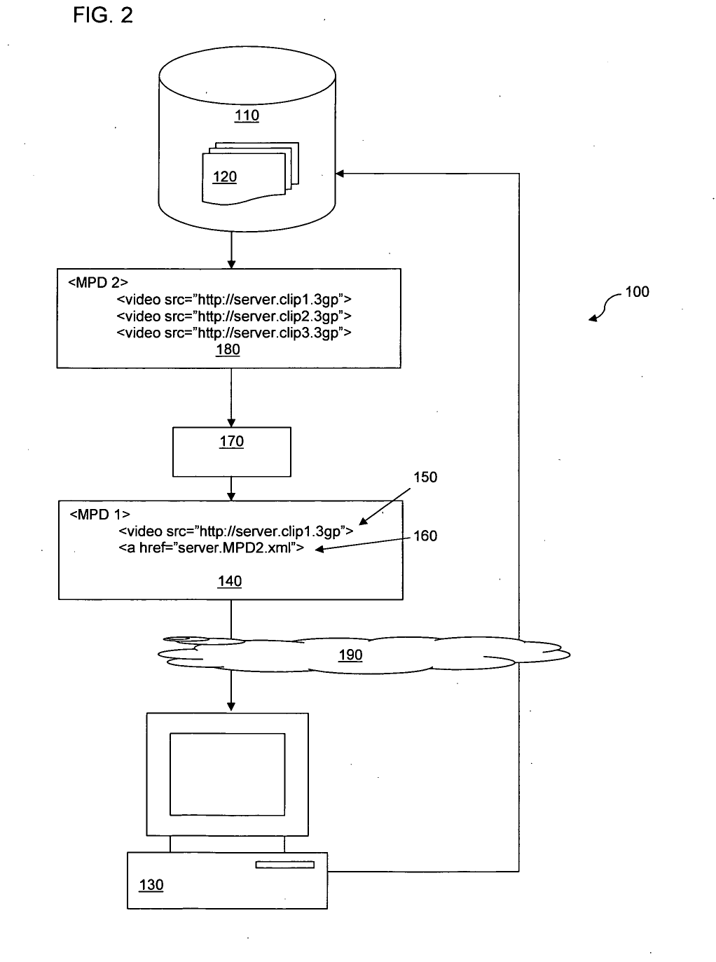

FIG. 2 shows a schematic diagram of a system 100 used to provide HTTP streaming media from a media server 110 to a client 130, which in this example is a computer running a browser.

For example, media server 110 may be a server having a suitable processor or processors (e.g. Intel Xenon or Itanium® server processors) operating media server software (e.g. Windows Media Services or Silverlight) as well as or instead of executing web server software (e.g. Apache or Microsoft IIS). Media server 110 may include suitable permanent storage such as hard disk drives or arrays of hard disk drives. The media server will also have a data connection (e.g. via HTTP) to a network such as the Internet.

The client 130 may be a home computer (e.g. having an Intel Pentium® CPU, motherboard, 1 TB hard disk drive, display, keyboard and mouse or iMac with Core i7 by Apple, Inc.) having a suitable browser (e.g. Internet Explorer or Safari). Alternatively, the client may be a smart phone such as an iPhone running iOS or Nokia N8 running Symbian, for example. Many different clients 130 may request and receive streamed media from one or more media servers 110.

The streaming media server 110 or connected storage contains media files and their associated MPD data 120. A user may click through within a browser session to start consuming HTTP streaming content in the form of audio-video, for example. The request GETs a reduced or initial MPD 140 across a network 190 such as the Internet. The initial MPD contains media segment references 150 as well as one or more links to a full MPD 160.

Once the initial MPD 140 is fully received, then the media data 170 starts to be streamed onto the client 130 by a user agent establishing the streaming content whilst rendering a first or initial portion of the media data on the browser. The link 160 in the initial MPD 140 in invoked by the client and a further request GETs the full MPD 180 from the sever 110.

As the full MPD 180 is downloaded whilst an earlier portion of the media data is being displayed, then this can be a silent process that does not cause a bottleneck or delay in media presentation.

Embedding a hyperlink for one MPD in another MPD may be referred to as MPD chaining and this can improve performance and start up times, especially with high length, tight segmentation and multiple alternative representation media. Implementation of such MPD chaining and hyperlinks may be included in a namespace extension of an MPD schema.

The MPD may be implemented as an XML file. The media data itself may be a live stream of data or pre-recorded video on demand, for example.

For example, the initial MPD 140 may cover the first 30 or 60 seconds of a media stream. For live streaming, then predictive MPD may be used for both the initial and full MPD downloads. Either or both the initial and full MPD may include a trick time mode where live media may be paused, played back or fast-forwarded, but appearing to be live streaming whilst “Now Time” content is being downloaded and cached.

The initial and/or full MPD may be imbedded in the media itself. In one example, this may be included as a flash manifest file and be part of an f4v file.

Following the initial GET request from the client 130, alternative initial MPDs 140 may be fetched and determined by the media server 110 depending on criteria including available band width, connection speed, client location and client preferences, for example. Therefore, the initial play back of a media stream may be optimised for a particular viewer so that the optional facilities available in the full MPD 180 (including language options etc.) are not required in the initial few seconds of streaming. In one example implementation the 3GP DASH standard may incorporate MPD chaining.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

Various embodiments discussed herein may be combined with each other in appropriate combinations in connection with the system described herein. Additionally, in some instances, the order of steps in the flowcharts, flow diagrams and/or described flow processing may be modified, where appropriate. Further, various aspects of the system described herein may be implemented using software, hardware, a combination of software and hardware and/or other computer-implemented modules or devices having the described features and performing the described functions. Software implementations of the system described herein may include executable code that is stored in a computer readable storage medium and executed by one or more processors. The computer readable storage medium may include a computer hard drive, ROM, RAM, flash memory, portable computer storage media such as a CD-ROM, a DVD-ROM, a flash drive and/or other drive with, for example, a universal serial bus (USB) interface, and/or any other appropriate tangible storage medium or computer memory on which executable code may be stored and executed by a processor. The system described herein may be used in connection with any appropriate operating system.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A method of streaming media data, comprising:
transmitting a first media description file and at least a portion of media data to a media renderer, wherein the first media description file contains initial data referencing segments of the media data used to start rendering the media data on the media renderer and a link to a second media description file associated with the media data; and
transmitting the second media description file to the media renderer in response to a request initiated by following the link contained in the first media file after the media renderer starts to render the media data, wherein the second media description file contains further data referencing segments of the media data used to continue rendering the media data on the media renderer.

2. The method of claim 1, wherein the second media description file is larger than then first media description file.

3. The method of claim 1, wherein the media renderer is selected from the group consisting of: video player, audio player, browser, computer, mobile device, cell phone, PDA, tablet computer, laptop computer and e-book reader.

4. The method of claim 1, wherein the link is a hyperlink.

5. The method of claim 1, wherein the first and second media description files are XML files.

6. The method of claim 1, wherein the first and second media description files are media presentation description, MDP files.

7. The method of claim 1, wherein the first media description file is less than 100 kB.

8. The method of claim 1, wherein the first media description file, the second media description file and the media data are transmitted over HTTP.

9. The method of claim 1, wherein the media data is a live stream of data.

10. A method of receiving streamed media data, comprising:
receiving on a media renderer a first media description file and at least a portion of media data, wherein the first media description file contains initial data referencing segments of the media data and a link to a second media description file associated with the media data;
initiating a rendering of the media data using the initial data contained in the first media description file;
issuing a request for the linked second media description file; and
receiving the second media description file in response to the request, wherein the second media description file contains further data referencing segments of the media data used to continue rendering the media data on the media renderer.

11. The method of claim 10, wherein the request for the second media description file is issued after the rendering of the media data starts.

12. The method of claim 10, wherein the second media description file is received during rendering of the media data.

13. The method of claim 10, wherein the media data and the media description files are communicated over a mobile network.

14. A non-transitory computer readable medium storing software for streaming media data, the software comprising:
executable code that transmits a first media description file and at least a portion of media data to a media renderer, wherein the first media description file contains initial data referencing segments of the media data used to start rendering the media data on the media renderer and a link to a second media description file associated with the media data; and
executable code that transmits the second media description file to the media renderer in response to a request initiated by following the link contained in the first media file after the media renderer starts to render the media data, wherein the second media description file contains further data referencing segments of the media data used to continue rendering the media data on the media renderer.

15. A non-transitory computer readable medium storing software for receiving streamed media data, the software comprising:
executable code that receives on a media renderer a first media description file and at least a portion of media data, wherein the first media description file contains initial data referencing segments of the media data and a link to a second media description file associated with the media data;
executable code that initiates a rendering of the media data using the initial data contained in the first media description file;
executable code that issues a request for the linked second media description file; and
executable code that receives the second media description file in response to the request, wherein the second media description file contains further data referencing segments of the media data used to continue rendering the media data on the media renderer.

16. A streaming media server comprising:
a supply of media data; and
a processor arranged to:
receive from a requestor a request for media data and in response transmit to the requestor media data from the supply and a first media description file, wherein the first media description file contains initial data referencing segments of the media data used to start rendering the media data on the requestor and a link to a second media description file associated with the media data; and
transmit in response to a response from the requestor following the link the second media description file, wherein the second media description file contains further data referencing segments of the media data used to continue rendering the digital work on the media renderer.

17. The server of claim 16, wherein the second media description file is larger than then first media description file.

18. The server of claim 16, wherein the media renderer is selected from the group consisting of: video player, audio player, browser, computer, mobile device, cell phone, PDA, tablet computer, laptop computer and e-book reader.

19. The server of claim 16, wherein the request for the second media description file is issued after the rendering of the media data starts.

20. The server of claim 16, wherein the media data and the media description files are communicated over a mobile network.
